(19) United States
(12) Patent Application Publication
(10) Pub. No.: US 2008/0212449 A1
(43) Pub. Date: Sep. 4, 2008

(54) Optical Data Carrier System

(75) Inventors: Alexander Buryak, Kilara (AU); Kazimir Kolossovski, Australian Capital Territory (AU); Dmitrii Yu Stepanov, New South Wales (AU)

Correspondence Address: SCHWEGMAN, LUNDBERG & WOESSNER, P.A., P.O. BOX 2938, MINNEAPOLIS, MN, 55402, US

(73) Assignee: BANDWIDTH FOUNDRY PTY LTD, New South Wales (AU)

(21) Appl. No.: 10/565,691

(22) PCT Filed: Feb. 23, 2004
(86) PCT No.: PCT/AU04/00987

§ 371 Date: Mar. 11, 2008

(30) Foreign Application Priority Data
Jul. 23, 2003 (AU) 2003903802

(51) Int. Cl. G11B 7/00

(52) U.S. Cl. 369/103

(57) ABSTRACT

The present invention provides a method of holographically storing data as in a series of grating structures including m-level coded elements in an optical data carrier, wherein m≧2, the method comprising: forming a grating sampling function as a direct sum of N partial grating sampling functions, each partial grating sampling function having a phase (φ n) and amplitude (dₙ), wherein each dₙ has m possible values.

### FIELD OF THE INVENTION

The present invention relates broadly to optical data carriers. In particular the present invention relates to a method of optimising a sampling function for the holographic storing of data in an optical data carrier, to a method of storing data in a disk-shaped optical data carrier, to an optical data carrier disk and to a method of forming said disk.

### BACKGROUND OF THE INVENTION

Recent progress in communication transmission rates has not been matched by a growth in data storage capacity. For example 7 years ago the standard system communication speed was 1.6 Gb/s for a T1 carrier using copper wire and now it is 320 Gb/s (10 Gb×32 channels) using optical carriers. This equates to an improvement factor in communication transmission of 200. In comparison, over the same timefframe the corresponding standard data storage media capacity growth has been from approximately 0.8 GB for compact discs (CD) to approximately 10 GB for digital video discs (DVD), representing an improvement factor of only 12.5. This leaves, from a capacity/speed perspective, the state of development in storage technology lagging behind the state of development in transmission technology by a factor of 16.

Moreover the theoretical storage limit of standard plane surface pixel-based optical storage media of approximately 10 Gb per standard CD-sized disk has almost been reached using DVD technology.

Holographic data storage is a term given to technologies in which information is stored in form of volumetric structures written inside an optical recording medium. The high bit density arising from the three-dimensional volumetric nature of the storage process used in holographic data storage may contribute to addressing the shortfall in data storage technologies when compared to data transmission technologies as discussed above.

In at least preferred embodiments, the present invention seeks to provide a novel optical data carrier system which is suitable for taking advantage of the three-dimensional volumetric nature of an holographic data storage process.

### SUMMARY OF THE INVENTION

In a first aspect the present invention provides a method of holographically storing data as in a series of grating structures including m-level coded elements in an optical data carrier, wherein m≧2, the method comprising:

forming a grating sampling function as a direct sum of N partial grating sampling functions, each partial grating sampling function having a phase (φₙ) and amplitude (dₙ), wherein each dₙ has m possible values.

The method can further comprise, conducting an optimisation process to determine a set of phases φₙ for which a required maximum refractive index variation in the optical data carrier is related to N^{x}, where 0.5≦x≦1. The required maximum refractive index variation in the optical data carrier can be proportional to N^{x}. Preferably x≈0.5.

The step of forming a grating sampling function can comprise:

forming the sampling function as a direct sum of L groups of N partial grating sampling functions, each L×N partial grating sampling function having phases and amplitudes, represented by matrices φₙₗ, dₙₗ, respectively;

and wherein step of conducting the optimisation process comprises:

separating the matrix φₙₗ into sets of N phases corresponding to the N partial grating sampling functions in a given group, and one set of L phases between the L groups;

determining the sets of phases for each group of N partial grating sampling functions from a database having stored therein possible combinations of N coded data elements and associated sets of phases; and

conducting said optimisation process to determine the set of L phases between the L groups.

The optimisation process to determine the set of L phases between the L groups can comprises conducting the optimisation process to determine the set of L phases between the L groups for which a functional characteristic of the sampling function is minimised.

Preferably the functional characteristic of the sampling function being minimised is a mean-square deviation or maximum amplitude.

The optimisation process to determine the set of L phases between the L groups, can comprise applying a functional analysis to determine the set of L phases between the L groups for which a functional characteristic of the sampling function is minimised. The functional analysis can comprise a steepest descent (gradient) method.

The optimisation process to determine the set of L phases between the L groups may comprise approximating the functional characteristic of the sampling function utilising an aperiodic autocorrelation function.

The optimisation process to determine the set of L phases between the L groups may further comprise, deriving a gradient of the functional of the sampling function from a derivative of the aperiodic autocorrelation function.

The partial grating sampling functions may comprise one- or multi-dimensional functions.

In a second aspect the present invention provides an optical data carrier configured to store data in a plurality of grating structures, said optical data carrier having at least one data reading face through which the grating structures are optically accessible for reading, wherein each grating structure comprises a series of m-level coded elements, where m≧2, for storage of data.

A required maximum refractive index variation in the optical data carrier is preferably related to N^{x} and wherein 0.5≦x≦1. Preferably the required maximum refractive index variation in the optical data carrier is proportional to N^{x} and 0.5≦x≦1. Preferably x=0.5.

The optical data carrier is preferably disk-shaped. The grating structures may comprise one- or multi-dimensional grating structures.

The optical data carrier can comprise a rolled-up material strip in which the plurality of grating structures are formed. The optical data carrier may further comprise means for maintaining the material strip in a rolled-up state.

The means for maintaining the material strip in a rolled-up state may include, a curable material or a mechanical structure.

In another aspect the present invention provides a method of storing data in an optical data carrier, the method comprising the steps of:

storing the data in a material strip, and

arranging the material strip to form the optical data carrier having a reading face from which the stored data is optically accessible to enable reading the stored data.

The method may include arranging the material strip to form the data carrier comprises spooling the material strip into a disk-shaped optical data carrier.

Preferably the material strip comprises a photosensitive material strip, and the step of storing the data comprises inducing refractive index changes in the photosensitive material strip to form grating structures that holographically store the data, wherein a required maximum refractive index variation in the grating structures of the optical data carrier is related to N^{x} and wherein 0.5≦x≦1.

In a further aspect the present invention provides an optical data carrier comprising a material strip arranged in a manner such that data stored in the material strip is optically accessible from a reading face to enable reading of the data stored on the optical data carrier. The optical data carrier can be formed by spooling the material strip into a disk. The material strip can comprises a plurality of grating structures containing the optical data, wherein each grating structure is optically accessible from the reading face.

The optical data carrier can further comprise means for releasably maintaining the material strip in the disk shape.

In another aspect, the present invention provides a method of forming a disk configured to store data in a plurality optical data structures; obtaining a strip-like data carrier storing including the plurality optical data structures; and winding the strip-like data carrier into a disk. The step of obtaining a strip-like data carrier can include, writing the plurality optical data structures into a strip-like carrier substrate. The optical data structures are preferably grating structures having m-level coded elements where m≧2. The method may also include attaching adjacent layers of the strip-like data carrier to each other in the wound disk.

### BRIEF DESCRIPTION OF THE DRAWINGS

Illustrative embodiments of the present invention will now be described, by way of non-limiting example only, with reference to the accompanying drawings, in which:

FIG. 1a illustrates schematically a conventional “flat” storage of CD/DVD-type disk;

FIG. 1b illustrates schematically a holographic disk embodying the present invention;

FIG. 2 shows a four plots (a) to (d): plots (a) and (b) depict a two-level coding sequence in Fourier space; and plots (c) and (d) depict the corresponding amplitude of a grating in accordance with an embodiment of the invention without clipping and with clipping respectively;

FIG. 3 is a schematic drawing illustrating an optical data carrier writing system embodying the present invention; and

FIG. 4 is a schematic drawing illustrating an optical data carrier embodying the present invention.

### DETAILED DESCRIPTION OF THE EMBODIMENTS

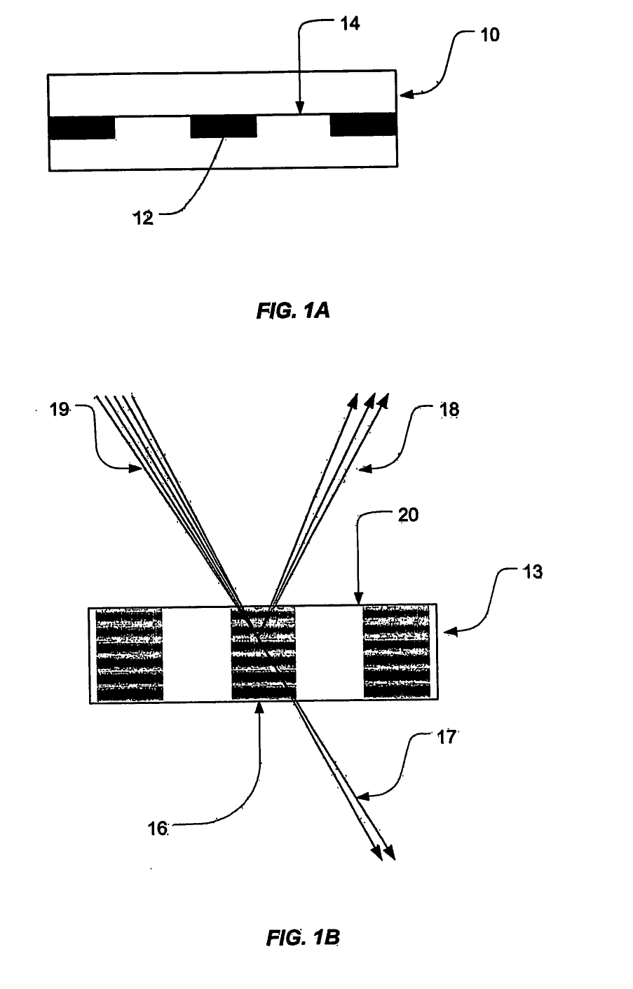

FIGS. 1A and 1B illustrate schematically the difference between conventional “flat” storage disks such as CD/DVD-type disks 10 (FIG. 1A) and an exemplary holographic disk 13 storage embodying the present invention (FIG. 1B). In a CD/DVD-type disk 10 of FIG. 1A data is stored as a pixels 12 formed on a planar surface 14. Each pixel, e.g. 12, on the 2D plane 14 can either reflects a scanning beam to a receiver (bit “1”) or away from the receiver (bit “0”).

In the disc 13 of FIG. 1B, the 2D array of pixels is retained, but instead of a single “flat” reflector a volumetric multi-channel grating e.g. 16 is used. The volumetric multi-channel grating 16 provides total reflection at certain set of angles indicated by the beams referenced with numeral 18), and which correspond to binary “1”s and provides total transmission at another set of angles referenced with numeral 17, to provide binary “0”s. Alternatively, instead of using different measurement angles, a set of measurements at different wavelengths can be performed. Thus it can be seen that each pixel e.g. 12, 14 of a CD/DVD-type disk 11 that is capable of storing one bit of information can be replaced by a holographic pixel 16 capable of storing one bit for each of the predetermined reflection angles or wavelengths.

Each of the gratings e.g. 16 is directly optically accessible from a reading face 20 of the disc 13, i.e. neighbouring gratings, are aligned along the reading face 20 so that no grating shadows its neighbour at any of the predetermined group optical reading beam incidence angles 19.

It will be shown below that for the standard semiconductor red laser wavelength (650 nm) such a multi-channel grating may have more than 1000 distinct channels meaning that each pixel e.g. 12 of the CD/DVD-type disk 10 can be replaced by a holographic pixel 16 storing more than 1000 bits of data.

Estimates related to the simplest (quasi 1D) holographic solutions:

The grating length Δz may be estimated from a simple formula: Δz≈1/Δδ where Δδ is the spectral width of grating. In this expression, the grating length Δz is measured in centimetres [cm] and the spectral width Δδis measured in special normalised units [1/cm], which are related to real life spectral width Δδₙₘ (e.g. in [nm]) as Δδ=20πn₀Δδₙₘ/λ², where λ is the grating central wavelength in microns. For example for λ≈0.65 micron and Δz=1 mm we get Δδₙₘ=0.023 nm.

The maximum number of channels N for a given λ and Δz is given as N≈0.2λ/Δδₙₘ(Δz). For example for λ≈0.65 micron and Δz=1 mm we get N≈6000.

An estimate for the maximum required refractive index change to create such a grating Δnₘₐₓ can also be made as follows.
In the first approximation one can express the grating amplitude parameter as

$$q ( z ) = - 2 {\int }_{- ∞}^{∞} \sqrt{R ( δ )} exp ( - 2 iδ z ) d δ ,$$

where R(δ) is reflectivity. Taking

\sqrt{R(δ)}=\sqrt{R}exp(−δ²/Δδ²)

one may further estimate

q(z)=−2\sqrt{π}Δδ\sqrt{R}exp(−z²Δδ²) or

|qₘₐₓ|=2\sqrt{πR}Δδ=2\sqrt{πR}/Δz

This gives an expression for Δnₘₐₓ of

Δnₘₐₓ=2λ₀n₀\sqrt{R/π}/Δz.

For R=0.5, λ₀=0.65 microns, n₀=1.5, and Δz=0.1 cm we get Δnₘₐₓ≈10⁻³, which is a realistic requirement for UV interferometric grating writing techniques.

However, it should be noted that this estimate is for a single channel grating only. If an N channel grating is to be written the necessary refractive index variation will increase by a factor of N, meaning that for any significant N the required maximum refractive index variation becomes prohibitively large, e.g. for N=1000, Δnₘₐₓ≈1

Thus if an N-channel grating is to be written an optimisation method is needed to reduce the required maximum refractive index variation to within physically acceptable limits. In the preferred embodiment of the present invention a dephasing optimisation scheme is used that reduces the factor of N by a factor of \sqrt{N}. Thus, for N=1000, the illustrative embodiment presented below gives an extra factor of about 30 or Δnₘₐₓ≈3·10⁻², which corresponds to state-of-the-art materials.

Moreover photosensitive materials capable of producing the refractive index change of Δnₘₐₓ≈10⁻¹ or more (together with other general requirements like low shrinkage, good mechanical properties, etc) may become available in the future.

The example embodiments to be described below provide a Fourier data encoding approach applicable to high capacity optical data storage and other fields, which can be implemented with readily available materials.

In the example embodiment, a one-level (identical signals) dephasing approach used for multi-channel fiber Bragg grating optimisation is modified to accommodate coded signals. Instead of using time-consuming fully numerical algorithms, the problem is simplified by calculating the so-called reduced mean deviation function and its derivatives with respect to phase values analytically, drastically reducing the amount of numerical calculation.

A block (convolution) optimization approach is applied, where the total number of encoded information elements is factorized and optimized in distinct steps. The present inventors have found that, by sacrificing the optimisation quality by a small amount (a few percent) substantial speed gains can be made in the numerical calculations.

As a result, the illustrative embodiment advantageously provides a fast and efficient m-level Fourier encoding optimization approach. Below it will be described for m=2, that is 2-level coded or binary elements, but it will be appreciated by a person skilled in the art that the present invention can be expanded or generalised to higher-level coded elements (i.e. m>2) without departing from the spirit or scope of the present invention.

Similar to a single-channel Fiber Bragg Grating (FBG), one bit of information can be written into a body of photosensitive material e.g. a holographic data disk, by irradiating the photosensitive material of the disk with laser light, the intensity profile of which is proportional to the grating design, and can be represented as follows:

q(z)=κ(z)exp[i(K₀z+θ(z))],

where z is the depth direction of the disk;
κ(z) is the grating amplitude
θ(z) is the grating phase, and
K₀ is the grating wave number.

The grating amplitude κ(z) is measured in cm⁻¹ and is related to the disk effective refractive index modulation Δn as:

κ(z)=πΔn(z)/(2Λ₀n₀),

where Λ₀ is the grating period and n₀ is the average refractive index of the disk. Recording L×N bits (N is the number of bits in a codeword, L is the number of codewords) into the disk can be accomplished via periodical modulation (i.e. sampling) of the one-bit design:

q(z)=κ(z)exp[i(K₀z+θ)]S(z),

where S(z) is a periodical sampling function (complex) with the period T=2π/Δk defined by the desirable inter-channel spacing Δk.

The first step of the example embodiment encoding algorithm deals with the specific representation of S(z). The sampling function is presented as the direct sum of L×N partial gratings, equally spaced in the frequency domain, and having relative phases φₙₗ and amplitudes dₙₗ={d₀, d₁}, n=1, . . . , N, l=1, . . . , L:

$$S ( z ) = {\sum }_{i = 1}^{L} {\sum }_{n = 1}^{N} {d}_{nl} exp [ i ( 2 n + 2 N ( l - 1 ) - 1 - NL ) Δ kz / 2 + {φ}_{nl} ) ] .$$

The second step is to transform two-dimensional matrixes dₙₗ, φₙₗ into a one-dimensional complex sequence mₚ, p=1, 2, . . . , NL, where m_{n+N(l-1)}=dₙₗ exp(iφₙₗ).

Complete optimization of the sampling function would comprise numerical search for all L×N phases φₙₗ based on modified prior art techniques. For a high number of the recorded bits (e.g. L×N>100) this approach may not be feasible due to excessive computational time. Therefore, in the example embodiment the number of variables is decreased by presenting the relative phases of the partial gratings in the form φₙₗ=φₙₗ^{N}+φₙ^{L}, where φₙₗ^{N} for a fixed l are the N phases that optimize the l-th codeword. The phases φₙₗ^{N} are taken from a database of preliminary results, i.e. they are not calculated.

Optimization of all possible codewords (i.e. all possible combinations of {d₀, d₁} levels), for example using prior art methods, might be accomplished as a preliminary step for creation of the database.

The rest of the phases, a set of L unknown variables φₗ^{L}, represents the relative phases between the codewords. Below is the detailed description of how to obtain these L phases in an efficient way in the example embodiment.

An algorithm to obtain L phases φₗ^{L} has been developed, which comprises two distinct steps: minimization of the mean-square deviation of the sampling function, followed by an iterative procedure for further peak amplitude degradation.

It has been shown that the peak amplitude of the sampling function is not high when its mean-square deviation is small. The mean-square deviation Δ(φ) of the sampling function can be approximated accurately by an expression measuring the total energy of the aperiodic autocorrelation function Cₖ of sequence mₚ:

$$Δ ( ϕ ) ≅ \frac{1}{\sqrt{2} NL} {( {\sum }_{k = 1}^{NL - 1} {\vert {C}_{k} \vert}^{2} )}^{1 / 2} , \\ where$$

$${C}_{k} = {\sum }_{p = 1}^{NL - k} {m}_{p + k} {m}_{p}^{*} , \\ k = 1 , 2 , … , NL - 1 ,$$

and “*” denotes complex conjugate.
The main advantage of this approximation is a high efficiency of the numerical calculations when searching for the optimal set of phases. It is based on the possibility to derive an analytical expression for the gradient (direction towards the optimum) of the objective function,

$$\frac{\partial Δ ( ϕ )}{\partial {ϕ}_{j}^{L}} = \frac{Δ ( ϕ )}{{\sum }_{k = 1}^{NL - 1} {\vert {C}_{k} \vert}^{2}} Re \{ {\sum }_{k = 1}^{NL - 1} {C}_{k}^{*} \frac{\partial {C}_{k}}{\partial {ϕ}_{j}^{L}} \} , \qquad ( 1 )$$

where Re stands for the real part of the expression. To calculate the above expression analytically we present the derivative of the autocorrelation function in the following form,

$$\frac{\partial {C}_{k}}{\partial {ϕ}_{j}^{L}} = {\sum }_{p = k + 1}^{NL} \frac{\partial {m}_{p}}{\partial {ϕ}_{j}^{L}} {m}_{p - k}^{*} + {\sum }_{p = 1}^{NL - k} {m}_{p + k} \frac{\partial {m}_{p}^{*}}{\partial {ϕ}_{j}^{L}} . \qquad ( 2 )$$

We also present the autocorrelation index k and the sequence index p as

k=k₁+N(k₂−1), p=p₁+N(p₂−1).

All possible values that indexes k and p can take in expressions (1) and (2) can be presented as three non-overlapping sub-sets:

k₂ε[1,L−1]∪k₁ε[1,N] [symbol] p₂=k₂∪p₁ε[1+k₁,N],

k₂ε[1,L−1]∪k₁ε[1,N] [symbol] p₂ε[1+k₂,L]∪p₁ε[1,N],

k₂L∪k₁ε[1,N−1] [symbol] p₂=L∪p₁ε[1+k₁,N].

For each of these sub-sets, calculation of the derivatives ∂mₚ/∂φⱼ^{L} is a trivial exercise, i.e. ∂mₚ/∂φⱼ^{L}=imₚδ_{j,p}_{₂}, where the Kronecker symbol

$${δ}_{j , i} = \{ \begin{matrix}1 , & j = 1 , \\ 0 , & j \neq l .\end{matrix}$$

Finally, the gradient of the mean-square deviation in the example embodiment can be calculated as

$$\frac{\partial Δ ( ϕ )}{\partial {ϕ}_{j}^{L}} = \frac{Δ ( ϕ )}{{\sum }_{k = 1}^{NL - 1} {\vert {C}_{k} \vert}^{2}} Im \{ {\sum }_{{k}_{1} = 1}^{N} [ \begin{matrix}{C}_{{k}_{1} + N ( j - 1 )} {\sum }_{{p}_{1} = {k}_{1} + 1}^{N} {m}_{{p}_{1} + N ( j - 1 )} {m}_{{p}_{1} - {k}_{1}}^{*} ++ \\ {C}_{{k}_{1} + N ( L - j )} {\sum }_{{p}_{1} = {k}_{1} + 1}^{N} {m}_{{p}_{1} + N ( L - 1 )}^{*} {m}_{{p}_{1} - {k}_{1} + N ( j - 1 )} ++ \\ {\sum }_{{k}_{2} = 1}^{j - 1} {C}_{{k}_{1} + N ( {k}_{2} - 1 )}^{*} {\sum }_{{p}_{1} = 1}^{N} {m}_{{p}_{1} + N ( j - 1 )} {m}_{{p}_{1} - {k}_{1} + N ( j - {k}_{2} )}^{*} ++ \\ {\sum }_{{k}_{2} = 1}^{L - j} {C}_{{k}_{1} + N ( {k}_{2} - 1 )}^{*} {\sum }_{{p}_{1} = 1}^{N} {m}_{{p}_{1} + N ( j - 1 )}^{*} {m}_{{p}_{1} + {k}_{1} + N ( j + {k}_{2} - 2 )}^{*}\end{matrix} ] \} .$$

The above analytical expression forms a basis for the gradient method to find L phases φⱼ^{L}, which minimize the mean-square deviation of sampling function S(z). One evaluation of both the mean-square deviation and its gradient requires in the order of N²L² operations, i.e. exactly the same number of operations as in the case of uniform reflection spectrum (related art). However, a significant increase in the speed of the algorithm is caused by the decreased dimensionality of the phase space (from L×N for related art methods to L for the method of the example embodiment).

This has been found to produce optimised sampling functions characterized by low peaks in the refractive index change. Further improvement is achieved in the example embodiment by using the second step of the optimisation procedure by a generalization of the iterative Gerchberg-Saxton algorithm or amplitude clipping.

The Gerchberg-Saxton algorithm can be successfully used in cases when a small out-of-band response is not too crucial and the requirements for the spectral resolution are not highly demanding. The key idea of the method is swapping between time/direction and frequency domains under the constraints that the amplitude of the complex sampling function is constant and the amplitudes of the central part of its spectrum are kept fixed to the desired levels. Iteratively, one translates virtually all modulations of the sampling function S(z) into its phase at the expense of appearance of small side-lobes in the spectrum of the envelope, the integral size of which is proportional to the mean-square deviation of S(z).

An iterative clipping procedure is favourable in cases when an absence of side-channels in the reflection spectrum is essential. A complex error function is constructed by clipping S(z) at some level S₀. By subtracting the Fourier transform of the error function from the finite spectrum of original S(z) and restoring the amplitude profile of the spectrum to the original form (which includes setting the out-of-band response to zero), one decreases the maximum peak value of S(z). By gradually increasing level S₀, one might significantly reduce the peak of the sampling function.

The advantages of the above described Fourier space encoding approach include: the possibility to encode m-level data (m≧2), i.e. to write structures into a photosensitive medium which lead to the m-level reflection spectrum; and increased processing speed, with a potential for real-time optimization of high capacity storage devices (up to 10⁹ bits/mnm²) based on the application of the developed block-coding approach.

The example embodiment is extendable for bit sequences of arbitrary length. One can present a bit sequence of arbitrary length as N×L₀×L₁×L₂× . . . L_{M}. In some cases, extra bits may be required to form the factorisation. In an extension of the example embodiment, one first optimises N×L₀ initial bits using the example embodiment described above. After that the algorithm is repeated with N×L₀×L₁ bit sequence, but taking N×L₀ as a “new” N and L₁ as a “new” L₀. Then, one can keep applying the algorithm, until the full bit sequence is optimised.

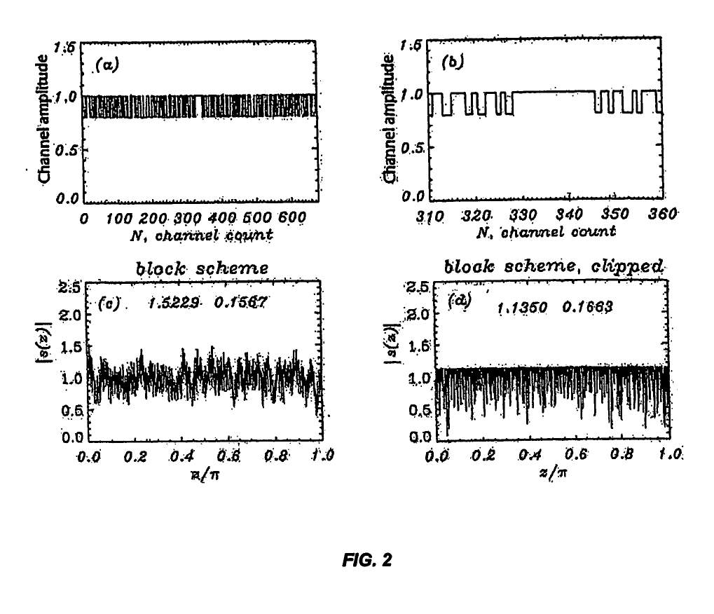

In FIGS. 2(a) and (b), a sample two-level coding sequence in Fourier space for 675 channels is shown to illustrate the potential of the present invention for storing a series of m-coded elements. The amplitude levels of the channels are 1.0 and 0.8. FIG. 2(b) shows the detail of a portion of channels depicted in plot (a). FIGS. 2(c) and (d) depict the normalized (divided by \sqrt{675}) amplitude variation of the grating design presented on one period of the grating, corresponding to the bit structure of plot (a) based on the optimisation process embodying the present invention. Plot (d) depicts the clipped version of the of the data presented in plot (c).

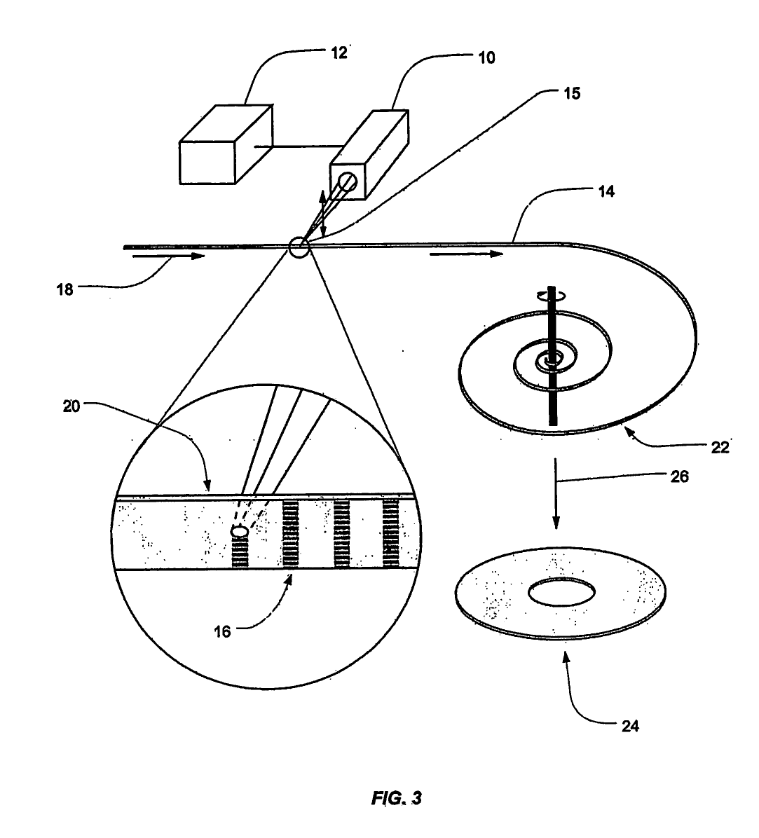

In the following, an example embodiment of an optical data carrier writing system will be described. In FIG. 3, an interferometric grating writing apparatus 10, under the control of a system controller 12, is utilised to write a sequence of transverse gratings (one- or multi-dimensional gratings) into a longitudinal strip-like waveguide. In the example embodiment a photosensitive optical strip 14 is continuously moved across an interference region 15 of the writing apparatus 10, as indicated by arrow 18.

The writing apparatus 10, under the control of the controller 12, is arranged such that each grating is written transversely across into the optical strip 14. The strip may be continually drawn past the writing beam in the writing process, in which case the writing apparatus 10 will have to be moved accordingly to write the gratings across the width of the strip 14. Alternatively the movement of the strip past the writing apparatus can be indexed such the at movement of the writing apparatus during writing is not required.

The optical strip 14, after having passed through the interference region 16 is then spooled into a disk-like shape as indicated by numeral 22. The strip 14 has a continuous reading face 20 along its length that lies generally perpendicular to the side of the strip 14 through which the grating structure was written, and through which the gratings (e.g. 16) are read. The spooling of the optical strip 14 is done so that in the finished disk 24 the continuous reading face 20 of the strip 14 is accessible by a reading beam. That is, the reading face 20 is parallel to the plane of the disk 22.

The spooled disk 22 is then subjected to further processing (indicated at arrow 26) for producing a substantially solid disk 24. In the example embodiment, a refractive index matching optical glue can be used to adhere neighbouring windings of the coiled optical strip to form the disk 24. In another embodiment, the strip is made of a polymer material which is fully cured only from one side, and the grating structure is written only in that portion, with the top of the initially cured side forming the reading face. After spooling the strip into the disk-shape, the disk-shaped spool 22 is then cured further to achieve a complete solidification of the spool into a disk 24. In other embodiments, a possibility to un-roll the disk, e.g. to re-record it, may be provided for. In one such an embodiment, mechanical strength can be given to the spool 22 to form the disk 24 by encircling the periphery of the spool in external plastic ring, the spool 22 may also be supported on a substrate to provide adequate strength for handling or use.

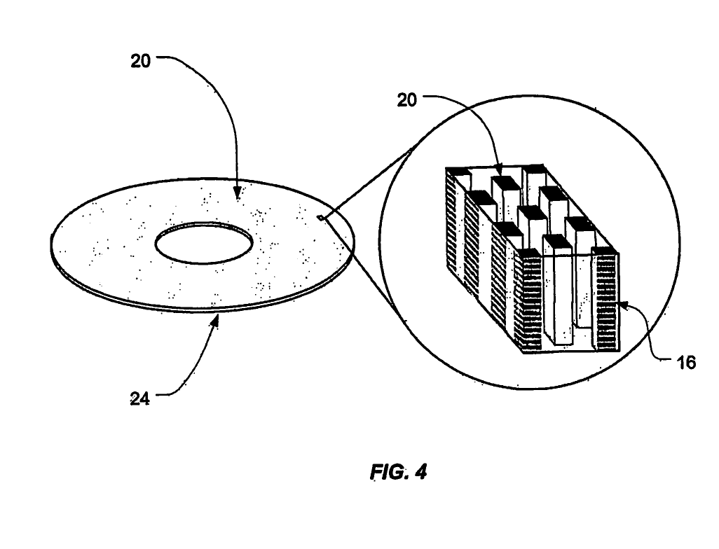

Turning now to FIG. 4, it is noted that in the completed disk 24, the reading face 20 lies within the plane of the disk 24. Accordingly, the disk 24 is suitable for data reading e.g. by reflection, similar to the reading conducted in conventionally CD/DVD-type disk readers. Reading may comprise illuminating the grating structure using a non-collimated beam, e.g. a converging beam as shown in FIG. 1B, so as to illuminate the grating structure at a plurality of incidence angles. The reflected beam, which will only reflect at certain angles, can then be detected by one or more detectors. The angles at which reflection occurs will correspond to the data encoded in the grating structure. It will be appreciated that the aspect of the present invention described with reference to the example embodiment in FIGS. 3 and 4 above, is not limited to the use with Fourier-based encoding techniques, but can be utilised for any other data recording/storage approaches.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, the partial grating sampling functions and thus the overall sampling function may be one- or multi-dimensional. Also, the grating structures need not necessarily be UV written. Rather, they may be created by other techniques, including e.g. “stamping” by a master strip or induced by other non-optical means such as e.g. pressure, chemicals, etc.

In some embodiments, to separate the gratings from each other in the spooled or rolled-up state to avoid/reduce cross-talk between channels, some parts of the material strip may be left blank or UV exposed uniformly, i.e. those areas do not have any gratings written/induced.

In the claims that follow and in the summary of the invention, except where the context requires otherwise due to express language or necessary implication the word “comprising” is used in the sense of “including”, i.e. the features specified may be associated with further features in various embodiments of the invention.

1. A method of holographically storing data as in a series of grating structures including m-level coded elements in an optical data carrier, wherein m≧2, the method comprising:
forming a grating sampling function as a direct sum of N partial grating sampling functions, each partial grating sampling function having a phase (φₙ) and amplitude (dₙ), wherein each dₙ has m possible values.

2. A method as claimed in claim 1, wherein the method further comprises:
conducting an optimisation process to determine a set of phases φₙ for which a required maximum refractive index variation in the optical data carrier is related to N^{x}, where 0.5≦x≦1.

3. A method as claimed in claim 2, wherein the required maximum refractive index variation in the optical data carrier is proportional to N^{x}.

4. A method as claimed in claim 2, wherein x≈0.5.

5. A method as claimed in claim 2, wherein the process of forming a grating sampling function comprises:
forming the sampling function as a direct sum of L groups of N partial grating sampling functions, each L×N partial grating sampling function having phases and amplitudes represented by matrices φₙₗ, dₙₗ, respectively, and wherein the process of conducting the optimisation process comprises:
separating the matrix φₙₗ into sets of N phases corresponding to the N partial grating sampling functions in a given group and one set of L phases between the L groups;
determining the sets of phases for each group of N partial grating sampling functions from a database having stored therein possible combinations of N coded data elements and associated sets of phases; and
conducting the optimisation process to determine the set of L phases between the L groups.

6. A method as claimed in claim 5, wherein the optimisation process to determine the set of L phases between the L groups comprises conducting the optimisation process to determine the set of L phases between the L groups for which a functional characteristic of the sampling function is minimised.

7. A method as claimed in claim 6, wherein the functional characteristic of the sampling function being minimised is a mean-square deviation or maximum amplitude.

8. A method as claimed in claim 6, wherein the optimisation process to determine the set of L phases between the L groups comprises applying a functional analysis to determine the set of L phases between the L groups for which a functional characteristic of the sampling function is minimised.

9. A method as claimed in claim 8, wherein the functional analysis comprises a steepest descent (gradient) method.

10. A method as claimed in claim 8, wherein the optimisation process to determine the set of L phases between the L groups comprises approximating the functional characteristic of the sampling function utilising an aperiodic autocorrelation function.

11. A method as claimed in claim 10, wherein the optimisation process to determine the set of L phases between the L groups further comprises deriving a gradient of the approximated functional characteristics of the sampling function from a derivative of the aperiodic autocorrelation function.

12. A method as claimed in claim 1, wherein the partial grating sampling functions comprise at least one of one-dimensional functions and multi-dimensional functions.

13. An optical data carrier configured to store data in a plurality of grating structures, said optical data carrier having at least one data reading face through which the grating structures are optically accessible for reading, wherein each grating structure comprises a series of m-level coded elements, where m≧2, for storage of data.

14. An optical data carrier as claimed in claim 13, wherein a required maximum refractive index variation in the optical data carrier is related to N^{x}, where 0.5≦x≦1 and N denotes a number of partial grating sampling functions from which the grating structure is formed.

15. An optical data carrier as claimed in claim 14, wherein the required maximum refractive index variation in the optical data carrier is proportional to N^{x}.

16. An optical data carrier as claimed in claim 14, wherein x≈0.5.

17. An optical data carrier as claimed in claim 13, wherein the optical data carrier is disk-shaped.

18. An optical data carrier as claimed in claim 13, wherein the grating structures comprise at least one of one-dimensional grating structures and multi-dimensional grating structures.

19. An optical data carrier as claimed in claim 13, wherein the optical data carrier comprises a rolled-up material strip in which the plurality of grating structures are formed.

20. An optical data carrier as claimed in claim 19, the optical data carrier further comprising at least one of a fixing material and a mechanical structure for maintaining the material strip in a rolled-up state.

21. An optical data carrier as claimed in claim 20, wherein the fixing material for maintaining the material strip in a rolled-up state comprises a curable material.

22. (canceled)

23. A method of storing data in an optical data carrier, the method comprising:
storing the data in a material strip, and
arranging the material strip to form the optical data carrier having a reading face from which the stored data is optically accessible to enable reading of the stored data.

24. A method as claimed in claim 23, wherein the process of arranging the material strip to form the data carrier comprises spooling the material strip into a disk-shaped optical data carrier.

25. A method as claimed in claim 24, wherein:
the material strip comprises a photosensitive material strip; and
the process of storing the data comprises inducing refractive index changes in the photosensitive material strip to form grating structures that holographically store the data, the grating structures of the optical data carrier having a required maximum refractive index variation which is related to N^{x}, where 0.5≦x≦1.

26. An optical data carrier comprising a material strip arranged in a layered manner such that data stored in the material strip is optically accessible from a reading face to enable reading of the data stored on the optical data carrier.

27. An optical data carrier as claimed in claim 26, wherein the optical data carrier is formed by spooling the material strip into a disk.

28. An optical data carrier as claimed in claim 26, wherein the material strip comprises a plurality of grating structures containing the optical data, each grating structure being optically accessible from the reading face.

29. An optical data carrier as claimed in claim 27, the optical data carrier further comprising at least one of a fixing material and a mechanical structure for releasably maintaining the material strip in the disk shape.

30. A method of forming a disk configured to store data in a plurality of optical data structures, the method comprising:
providing a strip-like data carrier for storing the plurality of optical data structures; and
winding the strip-like data carrier into a disk.

31. A method as claimed in claim 30, wherein the process of providing the strip-like data carrier includes writing the plurality of optical data structures into a strip-like carrier substrate.

32. A method as claimed in claim 30, wherein the optical data structures are grating structures having m-level coded elements, where m≧2.

33. A method as claimed in claim 30, the method further comprising attaching adjacent layers of the strip-like data carrier to each other in the disk.
